(19) United States
(12) Patent Application Publication
(10) Pub. No.: US 2002/0087376 A1
(43) Pub. Date: Jul. 4, 2002

(54) Trouble management system

(76) Inventor: Noriko Sugimoto, Kanagawa (JP)

Correspondence Address: ROBIN BLECKER & DALEY, 2ND FLOOR, 330 MADISON AVENUE, NEW YORK, NY, 10017, US

(21) Appl. No.: 10/007,198

(22) Filed: Oct. 19, 2001

(30) Foreign Application Priority Data
Oct. 24, 2000 (JP) 324350/2000

(51) Int. Cl. G06F 17/60

(52) U.S. Cl. 705/7

(57) ABSTRACT

Information about trouble contents, methods for dealing with troubles, product information obtained at the time of manufacture, information about users, etc., are managed to enable immediate notice of a method and contents of an operation for revolving a trouble at the time of occurrence of the trouble. Information on the progress of the operation performed to resolve the trouble is also managed to enable a person using or taking charge of the product to easily grasp the progress of the operation.

### BACKGROUND OF THE INVENTION

1. Field of the Invention

The present invention relates to a trouble management system for managing a trouble in a product.

2. Description of the Related Art

Conventionally, when a user using, for example, an ink jet printer encounters a trouble, e.g., fading of printed characters, he or she has a way to resolve the trouble by referring to a maintenance manual, by asking a solution from a telephone consulting service or the like of the manufacturer, or by consulting with the sales agency that sold the machine to the user.

However, the reliability of various products including ink jet printers has recently been improved, with the result that the cases where users actually encounter troubles in such products during use thereof are now becoming increasingly rare. Therefore, when users unfortunately happen to encounter such troubles in actuality, they find it very difficult to deal with them because of their limited experiences with such troubles.

For example, in a case where an ordinary user refers to a maintenance manual to resolve a trouble, it takes the user a long time to find an information item corresponding to the trouble to be resolved among a number of information items described in the manual. Moreover, after finding the corresponding item, it is considerably difficult for the user to determine whether the trouble is a result of his or her operational failure or a failure of the product itself.

In such a case, therefore, there is a need to ask for a solution from a telephone consulting service or the like of the manufacturer, to consult with the sales agency, or to bring the product to a shop of the sales agency and to have the product checked by an expert. Ordinarily, manufacturer's service receptions and sales agency shops are closed on holidays and at night. In many cases, therefore, it takes a long time to resolve a trouble.

### SUMMARY OF THE INVENTION

In view of the above-described problems, an object of the present invention is to provide a trouble management system capable of immediately and correctly dealing with trouble in a product encountered during use of the product by a user.

These and other objects and features of the present invention will become apparent from the following detailed description of embodiments of the invention in conjunction with the accompanying drawings.

### BRIEF DESCRIPTION OF THE DRAWINGS

FIG. 1 is a block diagram showing the configuration of a network system in accordance with the present invention;

FIG. 2 is a flowchart of the operation of a client trouble management system;

FIG. 3 is a flowchart of the operation of the client trouble management system;

FIG. 4 is a diagram showing an example of a data base managed in the client trouble management system;

FIG. 5 is a flowchart of the operation of the client trouble management system;

FIG. 6 is a flowchart of the operation of the client trouble management system;

FIG. 7 is a flowchart of the operation of the client trouble management system;

FIG. 8 is a flowchart of the operation of the client trouble management system;

FIG. 9 is a flowchart of the operation of the client trouble management system;

FIG. 10 is a block diagram showing the configuration of the network system of the present invention;

FIG. 11 is a flowchart of the operation of the client trouble management system;

FIG. 12 is a flowchart of the operation of the client trouble management system;

FIG. 13 is a flowchart of the operation of the client trouble management system; and

FIG. 14 is a diagram showing an example of a user interface for inputting a product delivery method.

### DETAILED DESCRIPTION OF THE PREFERRED EMBODIMENTS

Embodiments of the present invention will be described with reference to the accompanying drawings.

(First Embodiment)

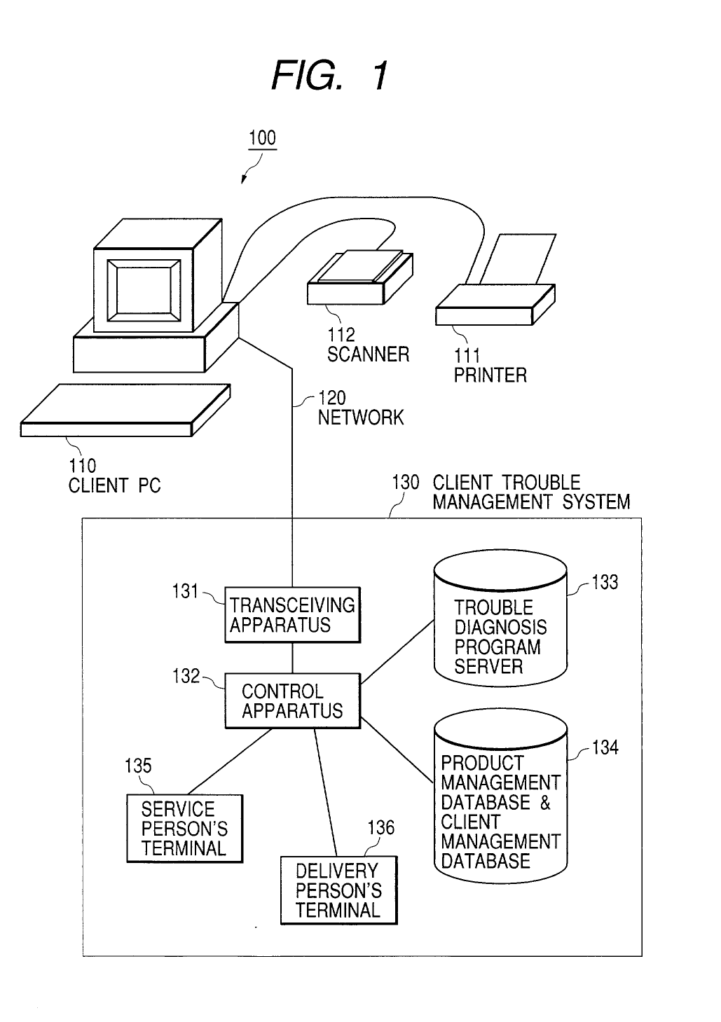

The present invention is applied to, for example, a network system 100 such as shown in FIG. 1.

The network system 100 of this embodiment is arranged so that, when a trouble occurs in a product (printer 111) during use of the product by a user, the user can inquire of a client trouble management system 130 in a service center about the trouble through a network 120 by using a terminal on the user side (client PC 110) to immediately obtain appropriate service including instructions based on a method for solving the trouble, determination as to whether a failure has occurred, designation of a need for service, and reception of a request for service.

Examples of various products usable in the system to which the present invention is applied in this embodiment (objects of management in accordance with the present invention) are an information processor such as a personal computer, peripheral devices such as a printer, a scanner and an external storage device connected to an information processor, and audiovisual devices such as a digital camera and a video recorder. In the following, for ease of description, only a printer 111 and a scanner 112 will be referred to as management-object products by way of example. In actuality, a plurality of users exist who can gain access to the client trouble management system 130. However, only one user will be mentioned for ease of description.

<Entire Configuration of Network System 100>

In the network system 100, the terminal on the user side (client PC) 110 and the client trouble management system 130 in the service center are connected through the network 120 such as the Internet so as to be communicable with each other.

The client PC 110 is, for example, a personal computer (PC) operated by the user. The client PC 110 can be connected to the client trouble management system 130 through the network 120.

The printer 111 and the scanner 112 are connected to the client PC 110. The printer 111 and the scanner 112 function as an apparatus for outputting image information and an apparatus for inputting image information, respectively, by being operated by the user.

The client trouble management system 130 is provided by the service center of the manufacturer/distributor of the printer 111 and the scanner 112.

The client trouble management system 130 includes a transceiving apparatus 131, a control apparatus 132, a trouble diagnosis program server 133, a product management database/client management database (hereinafter referred to simply as “data base”) 134, a terminal 135 used by a service person (hereinafter referred to as “service person's terminal”), and a terminal 136 used by a delivery person (hereinafter referred to as “delivery person's terminal”).

The transceiving apparatus 131 has functions for enabling the client trouble management system 130 to exchange information directly with the client PC 110, i.e., the function of receiving information sent from the client PC 110 and delivering the received information to the control apparatus 132, the functions of transmitting to the client PC 110 information, etc., retrieved from the data base 134 by the control apparatus 132 searching the data base 134, and other functions.

The control apparatus 132 includes a central processing unit (CPU), a memory and the like and has functions for overall control of the client trouble management system 130. For example, with respect to trouble information received from the client PC 110 and other information, the control apparatus 132 performs the following functions of:

1) performing trouble diagnosis by starting a trouble diagnosis program stored in advance in the trouble diagnosis program server 133;

2) writing user information and trouble diagnosis result information to the data base 134; and

3) sending a service operation start instruction and a delivery instruction to the service person's terminal 135 and the delivery person's terminal 136, respectively.

The trouble diagnosis program server 133 has the following programs stored therein in advance: a program (trouble diagnosis program) for performing diagnosis on the basis of trouble information received from the client PC 110 to confirm occurrence of a trouble and to determine a method of solving the trouble, a program for automatically diagnosing, in cooperation with the client PC 110, the causes of troubles in the printer 111 and the scanner 114 connected to the client PC 110, etc.

In the database (product management data base and client management database) 134 are stored information about manufacturing processes in which products (printer 111 and scanner 112 in this embodiment) were manufactured, information about the specifications of the products, the method of operating each product, information about service procedures and parts necessary for repair, information about product guarantees, etc. User registration information including the name and address of the user who purchased the products and the serial numbers of the purchased products is also stored in the database 134.

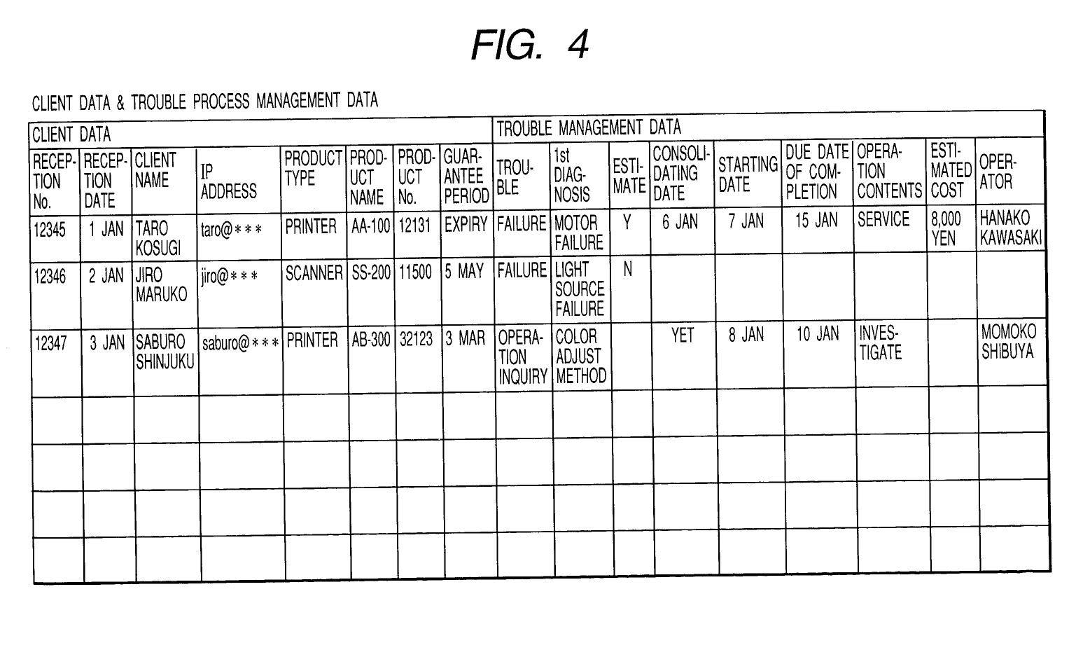

In the database 134 are also stored and managed various sorts of information such as shown in FIG. 4, i.e., user information received by the client trouble management system 130 from the client PC 110 at the time of occurrence of each of troubles, trouble product information, trouble contents information, information about the progress of service or investigation, etc.

The service person's terminal 135 and the delivery person's terminal 136 are PCs respectively placed in a service person's work place and a delivery person's management office or the like. When a request for delivery, service or the like sent by the user using the client PC 110 is received, the sections or persons in charge are informed of the contents of the request, a repairing method, etc., through these terminals. Also, through these terminals, the persons in charge input information about the progress and completion of delivery and service, etc., to the client trouble management system 130.

<Operation of Network System 100>

The operation of the network system 100 will now be described.

The operation in this embodiment will be described with respect to a case where a trouble has occurred such that the printer 111 outputs a print while failing to adjust a color to a user's preference, and where the cause of this print abnormality cannot be determined by the user.

(1) Reception of Trouble Information from User

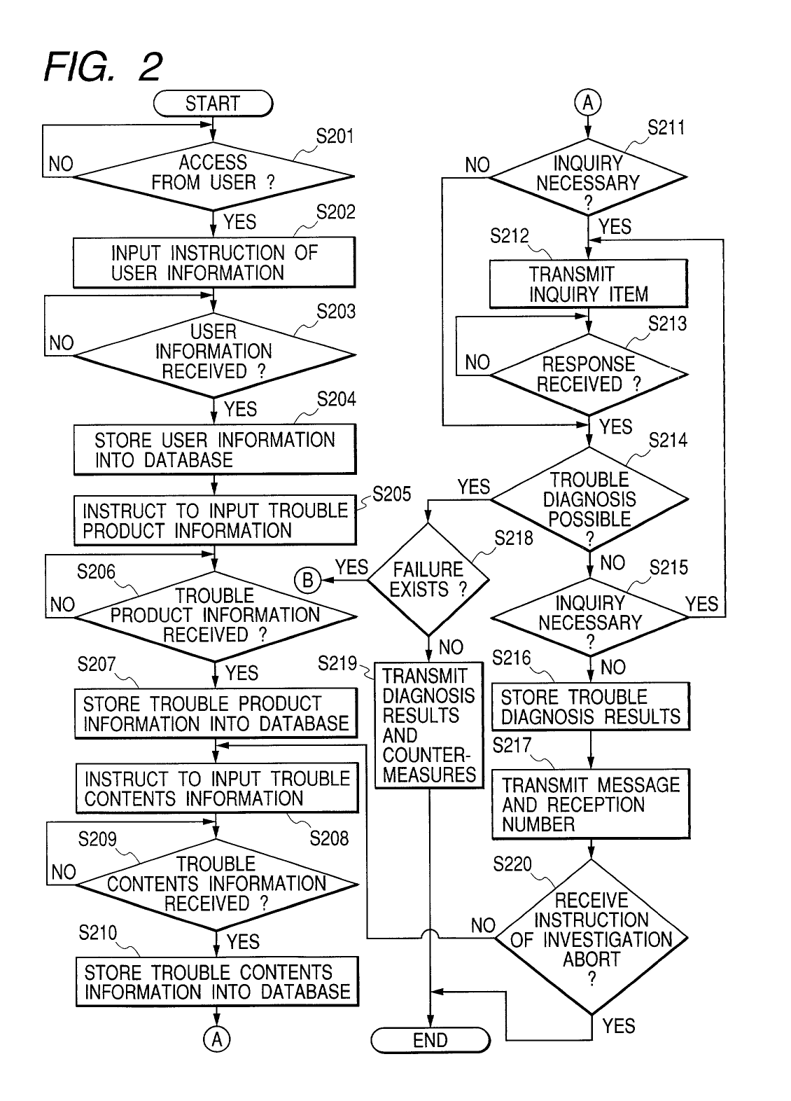

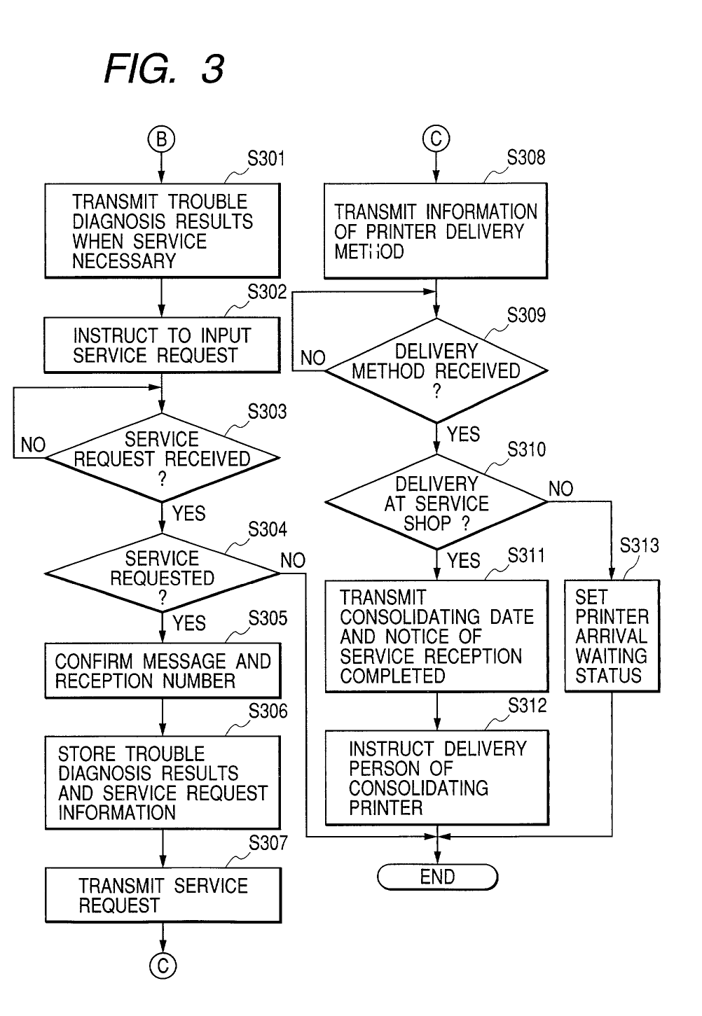

FIGS. 2 and 3 are flowcharts showing the operation of the client trouble management system 130 when the user encountering the trouble informs the client trouble management system 130 of the occurrence of the trouble by using the client PC 110.

First, the user encountering the trouble accesses the client trouble management system 130 through the network 120 by using the client PC 110.

The user may contact the client trouble management system 130 through the network 120 by using, instead of the client PC 110, a special terminal installed in a shop at which the printer 111 is sold. Alternatively, user may access the client trouble management system 130 by means of a tone signal or speech through a telephone line by using a telephone such as a push tone phone.

Step S201 (FIG. 2):

The control apparatus 132 checks whether an access from the client PC 110 to the transceiving apparatus 131 has been made.

Step S202:

If the control apparatus 132 determines in step S201 that an access from the client PC 110 has been made, the transceiving apparatus 131 transmits to the client PC 110 an instruction for input of user information including a name and an address of the client.

The user receiving the instruction from the client trouble management system 130 inputs user information by using the client PC 110.

Step S203:

The control apparatus 132 checks whether the transceiving apparatus 131 has received user information from the client PC 110. Step S204:

If the control apparatus 132 determines in step S203 that user information has been received, it adds a reception number and a reception date to the receiving information and stores the information in the database (client management database) 134 as shown in FIG. 4. FIG. 4 shows a case where an IP address, for example, is used as a user's address. However, a different sort of address information such as an e-mail address or a telephone number may alternatively be used.

Step S205:

The transceiving apparatus 131 transmits to the client PC 110 an instruction for input of trouble product information about the printer 111 in which the trouble has occurred, i.e., the type of the product, a product name, a model name, a serial number, etc.

The user receiving the instruction from the client trouble management system 130 inputs trouble product information by using the client PC 110.

Step S206:

The control apparatus 132 checks whether the transceiving apparatus 131 has received trouble product information.

Step S207:

If the control apparatus 132 determines in step S206 that trouble product information has been received, it stores the received trouble product information by relating the same to the user information stored in the database 134 in step S204.

Step S208:

The transceiving apparatus 131 transmits to the client PC 110 an instruction for input of trouble contents information for description of the trouble (information “the printer outputs a print while failing to adjust a color to a user's preference”).

The user receiving the instruction from the client trouble management system 130 inputs trouble contents information by using the client PC 110.

Step S209:

The control apparatus 132 checks whether the transceiving apparatus 131 has received trouble contents information.

Step S210:

If the control apparatus 132 determines in step S209 that trouble contents information has been received, it stores the received trouble contents information by relating the same to the user information stored in the database 134 in step S204.

Step S211:

The control apparatus 132 makes a determination on the basis of the trouble contents information received in step S209 as to whether there is a need for a detailed inquiry about the trouble that occurred.

Step S212:

If the control apparatus 132 determines in step S211 that there is a need for a detailed inquiry, it then makes the transceiving apparatus 131 transmit some inquiry item to the client PC 110. For example, if the printer 111 is a color ink jet printer, inquiry items are provided to check the remaining amounts of yellow, magenta and cyan inks and the set states of the properties of a printer driver.

The client PC 110 then produces an on-screen display suitable for the inquiry items to enable the user to input a reply.

Step S213:

The control apparatus 132 checks whether the transceiving apparatus 131 has received a reply from the client PC 110.

Step S214:

If the control apparatus 132 determines in step S213 that a reply has been received, it starts the trouble diagnosis program stored in the trouble diagnosis program server 133 in advance to make a determination as to whether trouble diagnosis can be performed, on the basis of the trouble product information received in step S206, the trouble contents information received in step S209 and, if necessary, the reply received in step S213 with respect to the inquiry items.

Step S215:

If the control apparatus 132 determines in step S214 that trouble diagnosis cannot be performed, it then makes a determination as to whether there is a need for further information or an inquiry item.

If the control apparatus 132 determines in step S215 that there is some other necessary inquiry item, the process moves to step S212 and this and sequent steps are executed.

Step S216:

If the control apparatus 132 determines in step S215 that there is no other necessary inquiry item, it stores in the database 134 a trouble diagnosis result indicating failure to perform trouble diagnosis.

Step S217:

The transceiving apparatus 131 transmits to the client PC 110 a message that trouble investigation will be continued and the reception number issued in step S204.

Step S220:

The control apparatus 132 makes a determination as to whether an instruction for abort of trouble investigation has been received from the client PC. If control apparatus 132 determines that no abort instruction has been received, the process returns to step S208 and this and subsequent steps are repeated to continue trouble investigation. The control apparatus 312 stores the progress of investigation in the database 134 by relating it to the reception number.

If control apparatus 132 determines that an abort instruction has been received, it cuts the connection between the client PC 110 and the client trouble management system 130. The process is thereby terminated.

Step S218:

If the control apparatus 132 determines in step S214 that trouble diagnosis can be performed, it then makes a determination as to whether the printer 111 has a failure on the basis of the received trouble product information and trouble contents information.

Step S219:

If the control apparatus 132 determines in step S218 that the printer 111 has no failure, the transceiving apparatus 131 transmits to the client PC 110 a trouble diagnosis result indicating that the printer 111 has no failure and information of a method for solving the trouble.

For example, the transceiving apparatus 131 transmits to the client PC 110 a message “the cause of the trouble is not a failure of the printer 111 but an inappropriate color adjustment setting in the properties of the printer driver” as a trouble diagnosis result, and “information about a color adjustment method” as a method for solving the trouble.

Step S301 (FIG. 3):

If the control apparatus 132 determines in step S218 (FIG. 2) that the printer 111 has a failure, the transceiving apparatus 131 transmits to the client PC 110 trouble diagnosis results indicating that the printer 111 needs a service. The transmitted trouble diagnosis results include, for example, information to be referred to by the user for judgment as to whether a request should be made for service for repairing the printer 111, e.g., details of the failure supposed, the probability of the failure, a service time and a service cost approximated, and various service conditions (whether the product is still under guarantee and can be repaired at no charge, and whether there is a system for estimation before execution of service).

Step S302:

The transceiving apparatus 131 transmits to the client PC 110 an instruction for requesting the user to input information as to whether the user wishes to obtain service on the printer 111 and whether the user requires an estimate.

The user receiving this instruction from the client trouble management system 130 inputs a service request notice.

Step S303:

The control apparatus 132 checks whether the transceiving apparatus 131 has received a service request notice. Step S304:

If the control apparatus 132 determines in step S303 that a service request notice has been received, it then makes a determination as to whether the received service request notice indicates that the user wishes to obtain service.

If the control apparatus 132 determines in step S304 that the user does not wish to obtain service, it cuts the connection between the client PC 110 and the client trouble management system 130. The process is thereby terminated.

Step S305:

If the control apparatus 132 determines in step S304 that the user wishes to obtain service, the transceiving apparatus 131 transmits to the client PC 110 a message that the request for service has been confirmed and a reception number.

Step S306:

The control apparatus 132 stores in the database 134 the trouble diagnosis results and service request information by relating the same to the user information stored in step S204 (FIG. 2).

Storage of the trouble diagnosis results in the database 134 may be executed between step S218 (FIG. 2) and step S301 (FIG. 3). This is advantageous in that the need for reinvestigation is eliminated with respect to a case where the user reconsiders his or her decision to decide to request service afterward.

Step S307:

The control apparatus 132 transmits to the service person's terminal 135 information indicating that the service request has been received. Simultaneously, the control apparatus 132 also transmits the reception number of service on the printer 111, user information, trouble product information and trouble contents information.

Step S308:

The transceiving apparatus 131 transmits to the client PC 110 information about a method for delivery of the printer 111. The printer delivery method is, for example, a method of bringing the printer 111 to a service shop such as a convenience store or a service station which exists near the user's place, and which is a place available for collection and delivery, or a method of directly sending the printer 111 to a manufacturer's service station by using a home delivery service or a postal service. The user can select one of such methods.

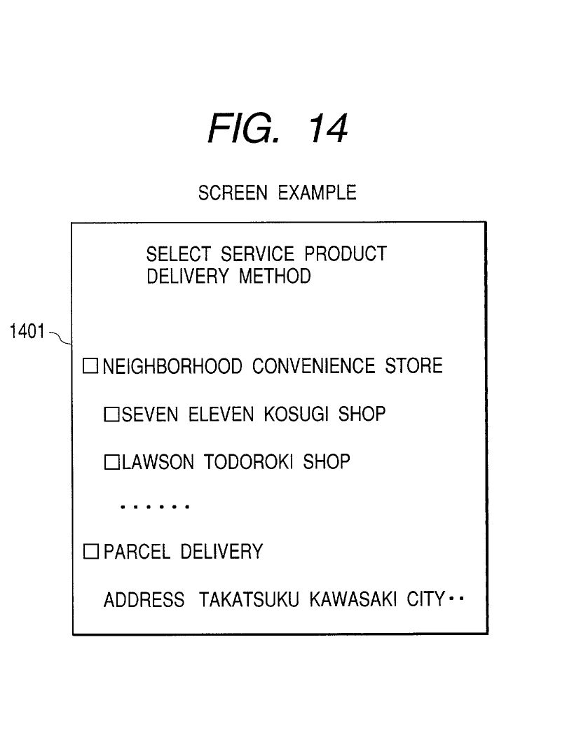

Also, an on-screen display 1401 such as shown in FIG. 14 is provided on the PC 110. The on-screen display 1401 contains the names of nearby service shops identified from the address information contained in the user information received in step S203 and the address to which the printer 111 is to be delivered in the case of delivery by a home delivery service.

The user can select a delivery method through this display according to his or her preference by operating the client PC 110.

Step S309:

The control apparatus 132 checks whether the transceiving apparatus 131 has received information about a delivery method.

Step S310:

If the control apparatus 132 determines in step S309 that information about a delivery method has been received, it then makes from the received information a determination as to whether the user wishes to perform delivery at a service shop such as a convenience store.

Step S311:

If the control apparatus 132 determines in step S310 that the user wishes to perform delivery at a service shop, it makes the transceiving apparatus 131 transmit to the client PC 110 a due consolidating date when the printer 111 can be consolidated, and information indicating that service reception is completed.

The control apparatus 132 then cuts the connection between the client PC 110 and the client trouble management system 130.

Step S312:

The control apparatus 132 transmits to the delivery person! S terminal 136 information about delivery of the printer 111, including a due delivery data.

The delivery person is thereby given an instruction for completion of delivery of the printer 111.

Step S313:

If the control apparatus 132 determines in step S310 that the user does not wish to perform delivery at a service shop, it sets a printer arrival waiting status. More specifically, it notifies the delivery person's terminal 136 that the printer will be consolidated by a home delivery service.

The control apparatus 132 then cuts the connection between the client PC 110 and the client trouble management system 130.

(2) Service Instruction to Service Person

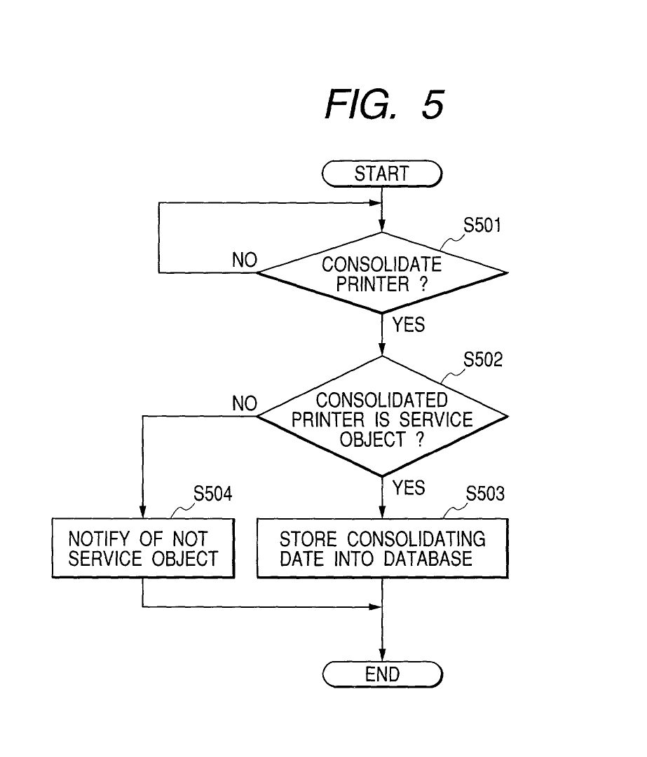

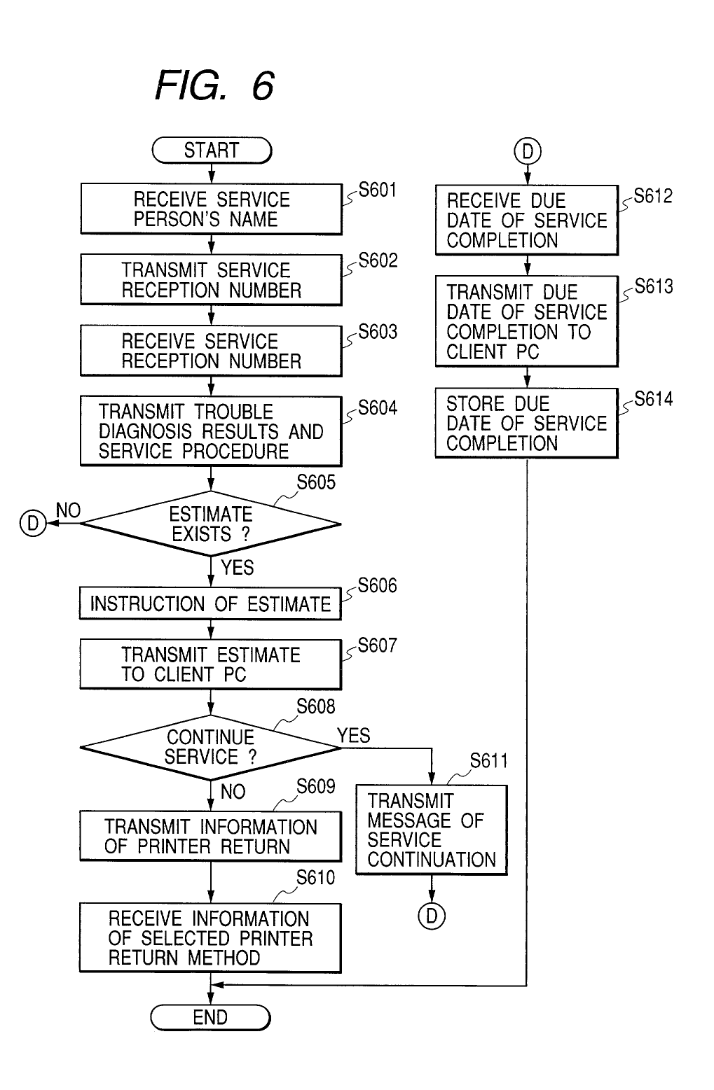

FIGS. 5 and 6 are flowcharts showing the operation of the client trouble management system 130 when a service is performed on the printer 111 at a request from the user.

A process shown in FIG. 5 will first be described.

Step S501:

The service person's terminal 135 receives a piece of electronic mail from the delivery person's terminal 136 by using a mail function to check whether the printer 111 has been consolidated to the delivery section by a home delivery service or via a service shop. This electronic mail includes the service reception number of service on the printer 111 and trouble product information.

Step S502:

The service person's terminal 135 checks whether the delivered printer 111 is the service object by collating the reception number, user information, trouble product information and trouble contents information transmitted from the control apparatus 132 in step S307 (FIG. 3) with the information about the printer 111 checked in step S501.

Step S503:

If the service person's terminal 135 determines in step S502 that the delivered printer 111 is the service object, it stores the consolidating date in the database (trouble management data) 134 by relating it to the reception number.

The process is thereby terminated.

Step S504:

If the service person's terminal 135 determines in step S502 that the delivered printer 111 is not the service object, it notifies the delivery person's terminal 136 of this result.

The process is thereby terminated A process shown in FIG. 6 will next be described.

Step S601:

The control apparatus 132 is notified of a state where the service person has become able to start service on the printer 111, and receives a service person's name. These sorts of information are input by the service person operating the service person's terminal 135.

Step S602:

The control apparatus 132 transmits to the service person's terminal 135 the service reception number corresponding to the service person's name received in step S601.

Step S603:

The control apparatus 132 receives the reception number again input by the service person for confirmation. Simultaneously, the control apparatus 132 receives various sorts of information necessary for the service person to start a service operation.

Step S604:

The control apparatus 132 transmits to the service person's terminal 135 the trouble diagnosis results (first trouble diagnosis results) stored in the database 134 in step S306 (FIG. 3).

Also, the control apparatus 132 retrieves a service procedure corresponding to the trouble diagnosis results stored in the database 134 in step S306 (FIG. 3) form basic service procedures related to each of causes of failure stored in the database 134 in advance, and transmits this service procedure to the service person's terminal 135.

The first trouble diagnosis results and the corresponding service procedure are then shown on the display of the service person's terminal 135.

Step S605:

The control apparatus 132 makes a determination as to whether the user wishes to receive an estimate on the basis of the information about the service request received from the user in step S303 (FIG. 3).

Step S606:

If the control apparatus 132 determines in step S605 that the user wishes to receive an estimate, it instructs the service person's terminal 135 to prepare an estimate by predicting a cost of service and a time period required for service from the information transmitted in step S604.

Step S607:

The control apparatus 132 makes the transceiving apparatus 131 transmit to the client PC 110 the estimate received from the service person's terminal 135.

Step S608:

The control apparatus 132 makes a determination as to whether service will be continued on the basis of a reply made by the user to the estimate and received from the client PC 110 by the transceiving apparatus 131.

Step S609:

If the control apparatus 132 determines in step S608 to cancel service, the transceiving apparatus 131 transmits to the client PC 110 information about return of the printer 111. This return information is information for selecting one of return methods similar to the delivery methods described above with respect to step S308 (FIG. 3).

Step S610:

The transceiving apparatus 131 receives from the client PC 110 a return method selected by the user.

The printer 111 is returned to the user on the basis of the information received in step S610, thereby terminating this process.

Step S611:

If the control apparatus 132 determines in step S608 that service will be continued, it transmits to the service person's terminal 135 a message that the service person should continue service.

Step S612:

The control apparatus 132 receives from the service person's terminal 135 a due date of completion of service on the printer 111.

Step S613:

The control apparatus 132 makes the transceiving apparatus 131 transmit to the client PC 110 the due date of service completion received in step S612.

Step S614:

The control apparatus 132 stores in the database 134 the due date of service completion received in step S612.

This process is thereby completed and the service person performs service operations on the printer 111. At this time, service operations may be performed on the basis of service assistance functions described below with respect to a third embodiment of the present invention.

(3) Service on Printer 111 by Service Person

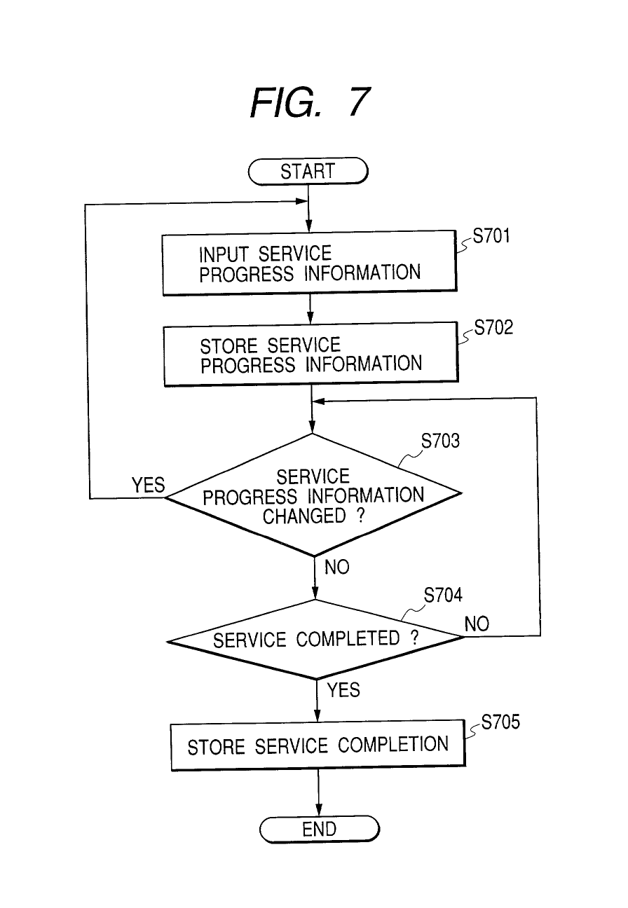

A process of storing information about the progress of service while the service person is performing service on the printer 111 will be described with reference to FIG. 7.

Step S701:

The service person inputs to the service person's terminal 135 information about the progress of service, i.e., the due date of service completion predicted from the first trouble diagnosis results shown on the display of the service person's terminal 135, the operation contents, the date of delivery of the printer 111, a date of starting of service operations, the progress of the service operations, etc.

Step S702:

The service person's terminal 135 transmits to the control apparatus 132 the information about the progress of service input in step S702. Also, the control apparatus 132 stores the information about the progress of service in the database 134.

Step S703:

The service person's terminal 135 checks whether, while the process of performing service operations on the printer 111 is advancing, an input has been made by the service person to indicate occurrence of a change in the service progress information input in step S701. If such an input is recognized, the process returns to step S701 and the service person newly inputs information about the operation contents and the progress of service to the service person's terminal 135.

Step S704:

The service person's terminal 135 checks whether, while the process of performing service operations on the printer 111 is advancing, the service person has made an input indicating that the service on the printer 111 is completed.

Step S705:

If the service person's terminal 135 determines in step S704 that such an input has been made, it transmits to the control apparatus 132 service progress information that the service is completed. Also, the control apparatus 132 stores this information about the progress of service in the database 134.

The service person's terminal 135 then terminates this process.

(4) Inquiry from User

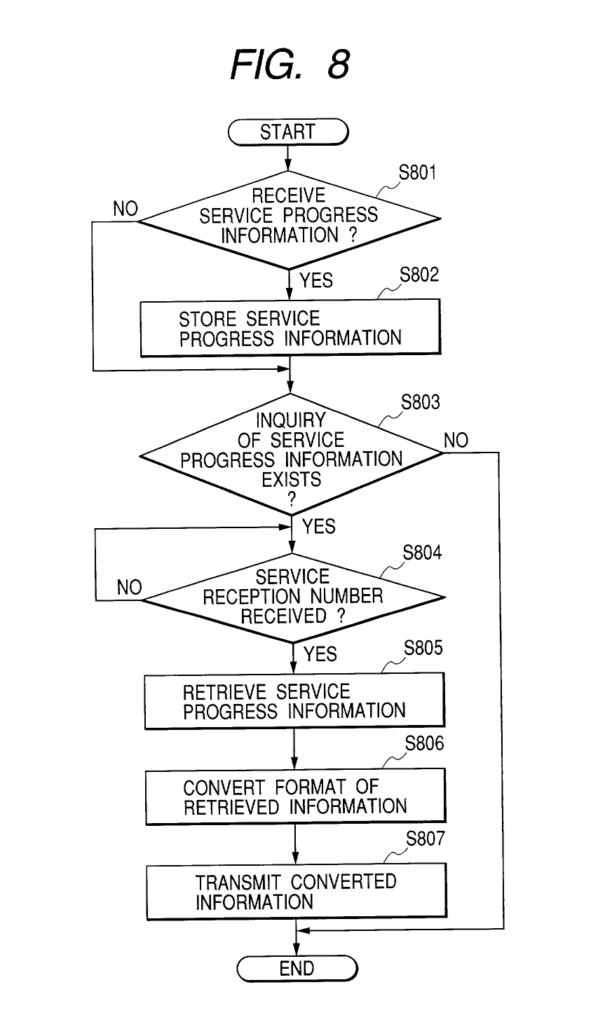

FIG. 8 shows the operation of the client trouble management system 130 when an inquiry about the progress of service on the printer 111 is received from the client PC 110.

Step S801:

The control apparatus 132 checks whether information about the progress of service has been received from the service person's terminal 135.

Step S802:

If the control apparatus 132 determines in step S801 that information about the progress of service has been received, it stores the received service progress information in the database 134 by relating it to the reception number.

Step S803:

The control apparatus 132 checks whether an inquiry about the progress of service on the printer 111 has been made.

Step S804:

If the control apparatus 132 determines in step S803 that an inquiry has been made, it checks whether the reception number has been received by the transceiving apparatus 131.

Step S805:

If the control apparatus 132 determines in step S804 that the reception number has been received, it reads out from the database 134 the information about the progress of service corresponding to the received reception number.

Step S806:

The control apparatus 132 converts the information retrieved in step S805 into a format most suitable for transmission to the client PC 110.

Step S807:

The transceiving apparatus 131 transmits to the client PC 110 the data converted in step S806. The control apparatus 132 then cuts the connection between the client PC 110 and the client trouble management system 130, thereby terminating this process.

(5) Notice of Completion of Service and Trouble Investigation

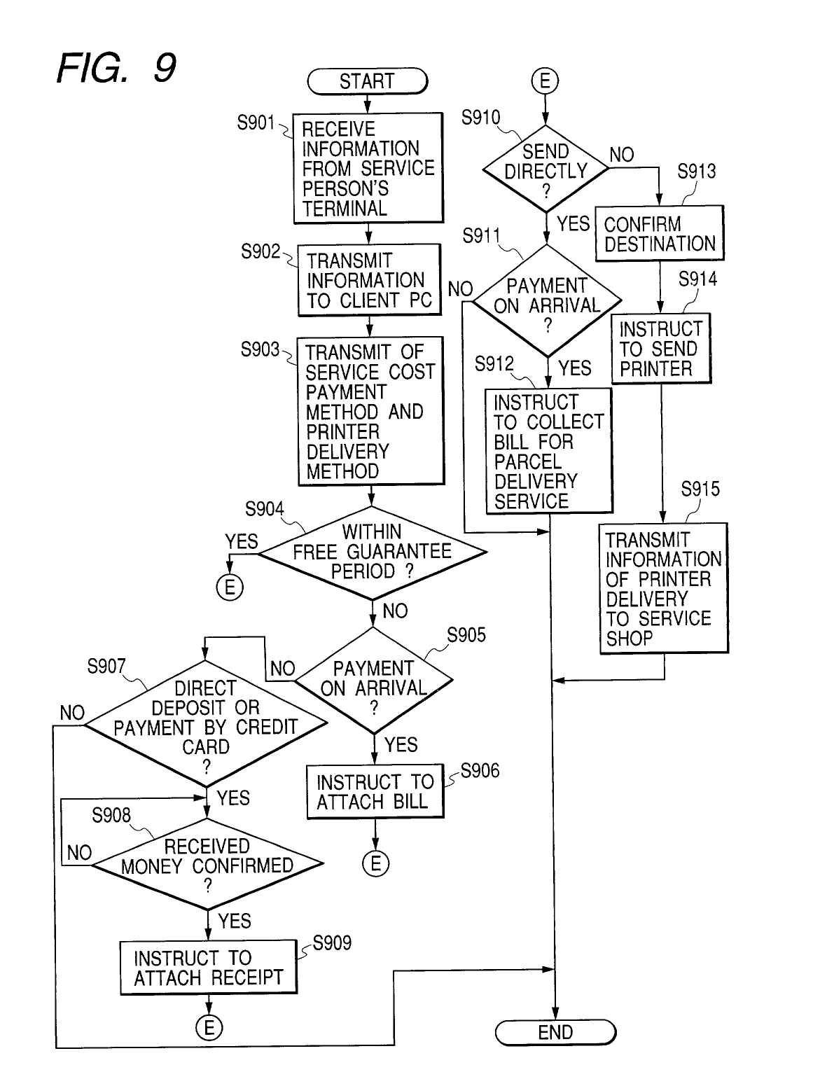

FIG. 9 shows the operation of the client trouble management system 130 at the time of sending of a notice of completion and the printer 111 after the completion of investigation of the trouble of the printer 111 and service on the printer 111 performed by the service person.

Step S901:

The control apparatus 132 receives from the service person's terminal 135 necessary information items, i.e., the reception number, the serial number of the printer 111, the cause of failure determined, service contents, contents and results of inspection after service, the cost of service, etc. These information items are input by the service person operating the service person's terminal 135.

Also, the service person delivers the printer 111 fixed by service to the delivery section.

Step S902:

The transceiving apparatus 131 transmits to the client PC 110 the information received in step S901 (necessary information items, i.e., the reception number, the serial number of the printer 111, the cause of failure determined, service contents, contents and results of inspection after service, the cost of service, etc.).

Step S903:

The transceiving apparatus 131 transmits to the client PC 110 an instruction for requesting the user to input a payment method and a delivery method according to his or her preference as well as information about a plurality of methods for service cost payment and methods for delivery of the product after service.

The user receiving this instruction and information from the client trouble management system 130 inputs a payment method and a delivery method according to his or her preference by operating the client PC 110.

Step S904:

The control apparatus 132 makes a determination as to whether service on the printer 111 has been performed within the free guarantee period.

If the control apparatus 132 determines in step S904 that service has been performed within the free guarantee period, the process moves to step S910 described below.

Step S905:

If the control apparatus 132 determines in step S904 that service is not within the free guarantee period, it then makes a determination as to whether the user has selected payment on arrival as a method of service cost payment on the basis of the information received in step S903.

Step S906:

If the control apparatus 132 determines in step S905 that payment on arrival has been selected, it transmits to the delivery person's terminal 136 instruction for making the delivery person attach a service charge bill at the time of sending of the printer 111.

Step S907:

If the control apparatus 132 determines in step S905 that payment on arrival has not been selected, it then makes a determination as to whether the user has selected a payment method such as direct deposit or payment by a credit card on the basis of the information received in step S903.

Step S908:

If the control apparatus 132 determines in step S907 that a payment method such as direct deposit or payment by a credit card has been selected, it then checks whether receipt of money by direct deposit or payment by a credit card is completed.

Step S909:

If the control apparatus 132 confirms receipt of money in step S908, it makes the transceiving apparatus 131 transmit to the delivery person's terminal 136 information for instructing the delivery person to attach a receipt at the time of sending of the printer 111.

Step S910:

The control apparatus 132 makes a determination as to whether direct sending of the printer 111 to, for example, the user's house by a parcel delivery or the like has been designated.

Step S911:

If the control apparatus 132 determines in step S910 that direct sending will be performed, it then makes a determination as to whether payment on arrival has been selected as a method of payment of a charge for the parcel delivery.

Step S912:

If the control apparatus 132 determines in step S911 that payment on arrival has been selected, it transmits to the delivery person's terminal 136 “information for instructing the delivery person to send the printer 111 by the parcel delivery and to collect the bill for the parcel delivery”.

The printer 111 fixed by service is thereafter returned to the user, and this process is terminated.

Step S913:

If the control apparatus 132 determines in step S910 that direct sending will not be performed, since it means, for example, delivery via a service shop such as a convenience store has been selected, the control apparatus 132 confirms the destination of the printer 111.

Step S914:

The control apparatus 132 transmits to the delivery person's terminal 136 information for instructing the delivery person to send the printer to the destination confirmed in step S913.

Step S915:

The control apparatus 132 transmits the information about delivery of the printer to a terminal (not shown) provided in the service shop (a convenience store or the like) corresponding to the destination confirmed in step S913.

The printer 111 fixed by service is thereafter delivered to the service shop designated by the user, and this process is terminated.

(Second Embodiment)

A second embodiment of the present invention will be described by referring to automatic diagnosis functions for automatically diagnosing a trouble in the printer to determine the cause of the trouble. To perform automatic diagnosis, printer driver software 110a and printer control software 111a installed in the client PC 110 in advance are executed by being linked to each other and automatic trouble diagnosis is performed with respect to the trouble inquiry item made in steps S212 and S213 of the process shown in FIG. 2.

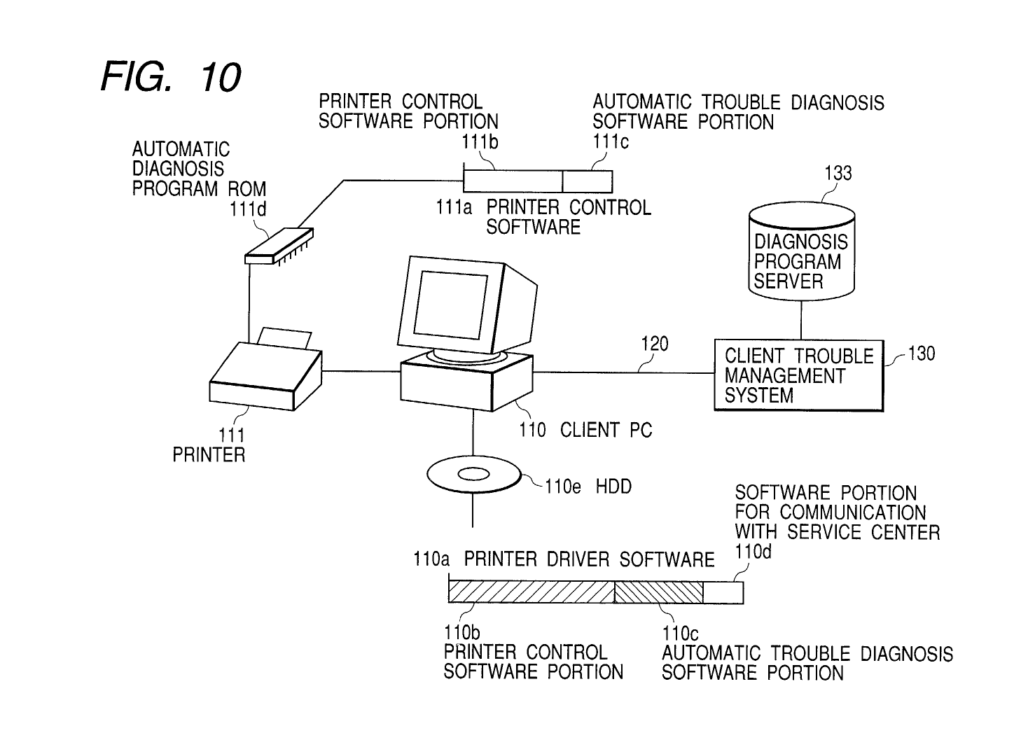

The system configuration in this embodiment will be described with reference to FIG. 10.

Printer driver software 110a is installed in a hard disk drive (HDD) 110e incorporated in the client PC 110.

Printer driver software 110a includes a printer control software portion 110b, an automatic trouble diagnosis software portion 110c, and a software portion 110d for communication with the client trouble management system 130.

An automatic diagnosis program ROM 111d incorporated in the printer 111 has printer control software 111a programmed therein.

Printer control software 111a includes a printer control software portion 111b and an automatic trouble diagnosis software portion 111c.

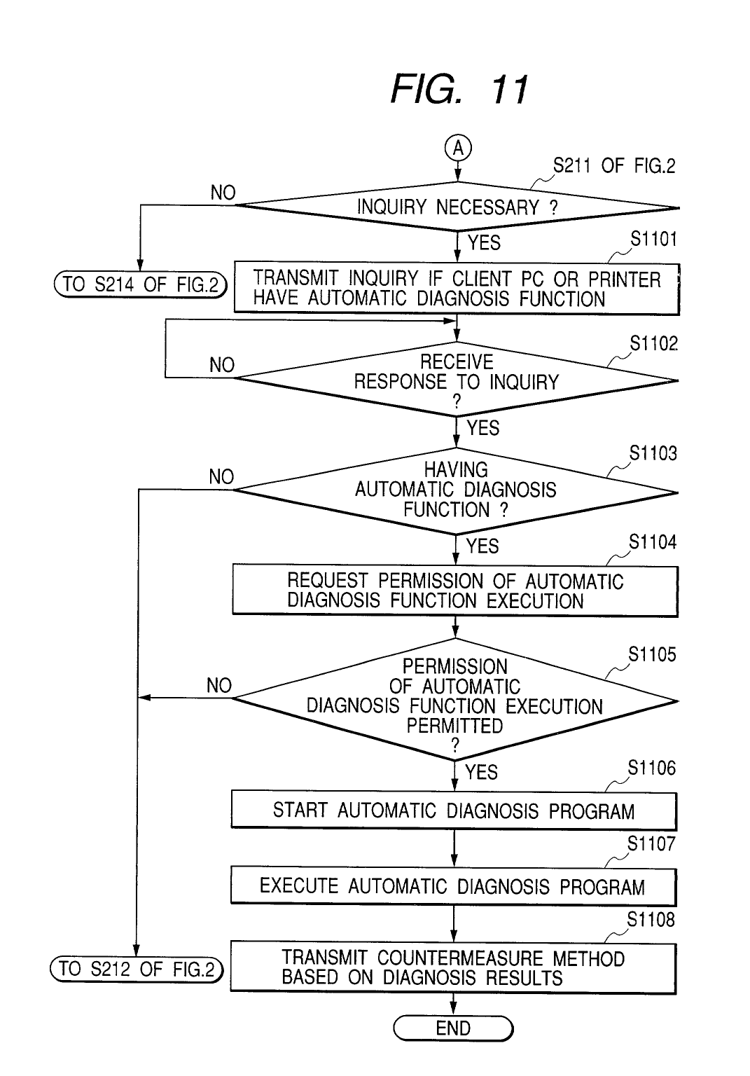

FIG. 11 is a flowchart showing a process using automatic trouble diagnosis functions in the trouble management system 130, which process is performed by executing the automatic trouble diagnosis software portion 110c.

Step S1101:

If it is determined in step S211 of FIG. 2 that there is some inquiry item, the transceiving apparatus 131 in the client trouble management system 130 transmits to the client PC 110 a signal for inquiry as to whether the client PC 110 and the printer 111 connected to the client trouble management system 130 have the automatic diagnosis functions.

Step S1102:

The transceiving apparatus 131 receives from the client PC 110 a signal representing a reply made in response to the inquiry signal transmitted in step S1101.

Step S1103:

The control apparatus 132 makes a determination as to whether the client PC 110 and the printer 111 have the automatic diagnosis functions, on the basis of the reply signal received in step S1102.

If the control apparatus 132 determines in step S1103 that the client PC 110 and the printer 111 do not have the automatic diagnosis functions, the process moves to step S212 of FIG. 2 and this and subsequent steps are executed.

Step S1104:

If the control apparatus 132 determines in step S1103 that the client PC 110 and the printer 111 have the automatic diagnosis functions, the transceiving apparatus 131 transmits to the client PC 110 information for notice of the existence of the automatic diagnosis functions and for requesting permission to execute the automatic diagnosis functions.

The user then inputs a signal for permission to execute the automatic diagnosis functions or inhibition of execution of these functions and transmits the signal to the client trouble management system 130 by using the client PC 110.

Step S1105:

The control apparatus 132 makes a determination as to whether the transceiving apparatus 131 has received the signal for permission to execute automatic diagnosis.

If the control apparatus 132 determines in step S1105 that the signal for permission to execute automatic diagnosis has not been received, the process moves to step S212 of FIG. 2 and this and subsequent steps are executed.

Step S1106:

If the control apparatus 132 determines in step S1105 that the signal for permission to execute automatic diagnosis has been received, it starts a program in the automatic trouble diagnosis software portion 110c on the client PC 110 by using a program in the software portion 110d for communication with service center.

Thus, a program in the automatic trouble diagnosis software portion 111c in the printer 111 is also started.

Step S1107:

The control apparatus 132 instructs the printer driver software 110a in the client PC 110 to perform investigation for determining the cause of a trouble on the basis of trouble contents information received from the client PC 110 by the transceiving apparatus 131 in step S209 of FIG. 2.

For example, the trouble contents information designates a trouble such as failure to obtain a print adjusted in color in accordance with a user's preference, the control apparatus 132 in the client trouble management system 130 instructs the printer driver software 110a in the client PC 110 to perform investigation for determining the cause of the print color abnormality.

The automatic trouble diagnosis software portion 110c of the printer driver software 110a in the client PC 110 receiving the instruction from the control apparatus 132 instructs the printer 111 to check whether ink of each color (e.g., each of yellow, magenta, cyan and black) exists.

The automatic trouble diagnosis software portion 111c of the printer control software 111a in the printer 111 receiving the instruction from the automatic trouble diagnosis software portion 110c of the printer driver software 110a in the client PC 110 checks the existence of each color ink and notifies the client trouble management system 130 of check results (results of automatic diagnosis) through the client PC 110.

For example, if the existence of each color ink is thus confirmed, the automatic trouble diagnosis software portion 111c instructs the printer 111 to perform printing for a test to be made in the event of a print abnormality and notifies the client trouble management system 130 that it instructed the printer 111 to perform print-abnormality test printing. The printer 111 executes processing for maintenance of the printing head in accordance with the instruction from the automatic trouble diagnosis software portion 111c, and thereafter prints out a test pattern in each color with the color name. After confirming the completion of print output from the printer 111, the automatic trouble diagnosis software portion 111c notifies the client trouble management system 130 of the completion of test printing. Next, the client trouble management system 130 transmits to the client PC 110 information for instructing the user to check the printing result in each color. Thus, the cause of the trouble is ascertained on the basis of the results checked by the user. For example, if yellow is not printed, the cause of the trouble is thought be a malfunction of the yellow head or failure to correctly load the ink cartridge. Finally, the client trouble management system 130 is notified of the results (automatic diagnosis results) through the client PC 110.

Step S1108:

The control apparatus 132 makes the transceiving apparatus transmit to the client PC 110 a method for solving the trouble on the basis of the automatic diagnosis results notified in step S1107.

For example, in a case where some of the color inks in the printer 111 is used up, information for instructing the user to replenish ink is transmitted to the client PC 110 to be shown on the display.

As described above, automatic diagnosis for determining the existence of a failure or the cause of the trouble in the printer 111 is executed.

(Third Embodiment)

A third embodiment of the present invention will be described by referring to, in the network system 100 shown in FIG. 1, functions for assisting the service person in performing service operations.

In the database 134 of the client trouble management system 130, information about a plurality of products sold in the past, including the printer 111, is stored to offer to users the service as described in the above embodiments.

For example, information about product designs stored in the database 134 includes information about product specifications in which colors of ink used by each object product to output a print, volumes of ink, etc., are designated, information about optimization of performance based on selecting the kind of paper and the kind of the printing mode to be selected by using the printer driver with respect to the kind of image to be printed, and information about design changes made to achieve improvements in performance, a reduction in failure rate, etc.

Also, the dates of manufacture, information on manufacturing factories, production lines, etc., information on parts used in manufacture, data on the results of inspections of the products in the processes of manufacture, etc., are stored as information about the processes of manufacture of the products by being related to unique numbers (serial numbers) assigned to the products. If a plurality of changes have been made in the design of each object product, information as to which of the changes is reflected in the design result is also stored.

The database 134 also contains product disassembly/assembly methods and procedures each selected when some component in one product is repaired or replaced, the procedure of replacement of each out-of-order component, the procedure of inspection after repair, a standard time required for each procedure, the prices of replacement parts, charges for service operations, and a table which is used to determine the cause of a failure and measures to remove the failure from a trouble phenomenon in each product, and in which the causes of failures and measures supposed to be taken are shown by being related to each specific phenomenon. Each time the client trouble management system 130 operates in response to a trouble inquiry and a service request from a user, information is stored in the above-described table in which are shown the causes of failures and resolving measures corresponding to each specific phenomenon and information on the frequency of occurrence of each kind of trouble and the frequency of each cause is updated and stored.

Information stored in the database 134 as described above is also used for trouble diagnosis executed in step S218 shown in FIG. 2, and is also referred to for preparation of an estimate in step S606 shown in FIG. 6.

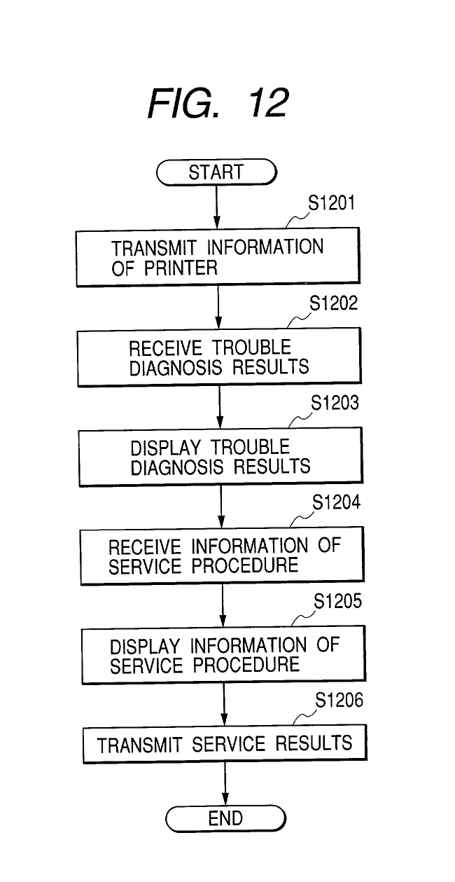

FIG. 12 is a flowchart of the operation of the client trouble management system 130 when service assistance functions for providing the service person with information about service operations are executed.

Step S1201:

The service person's terminal 135 transmits to the control apparatus 132 in the client trouble management system 130 the reception number, the product name, model name and the serial number of the printer 111 on which trouble investigation and service are to be performed, which information items have been input by the service person operating the terminal.

Thus, the control apparatus 132 performs collation of the reception number, the serial number, etc., of the printer 111 on the basis of the transmitted information to retrieve the necessary information items including first trouble diagnosis results from the database 134.

Step S1202:

The service person's terminal 135 receives the necessary information items retrieved from the database 134 by the control apparatus 132.

Step S1203:

The service person's terminal 135 shows on the display the necessary information items received in step S1202.

Step S1204:

The service person's terminal 135 receives the disassembly/assembly procedure and the service procedure for service with respect to a probable failure in accordance with the first trouble diagnosis results included in the necessary information items, product inspection data obtained at the time of manufacture corresponding to the serial number of the printer 111, information on the parts used, a standard time required for service, a charge for service, the prices of parts, etc.

Step S1205:

The service person's terminal 135 shows on the display the sorts of information received in step S1204.

Thereafter, the service person can perform final diagnosis of the trouble in the printer 111, determination of the cause, and service operations by using the information displayed on the service person's terminal 135, i.e., the information provided by the service assistance functions of the client trouble management system 130.

Step S1206:

The service person inputs the results of the service operations to the service person's terminal 135, and the service person's terminal 135 transmits the service operation results to the control apparatus 132. The control apparatus 132 stores the service operation results in the database 134. A record of the trouble in the printer 111 is also stored to thereby enrich the contents of the database 134.

(Fourth Embodiment)

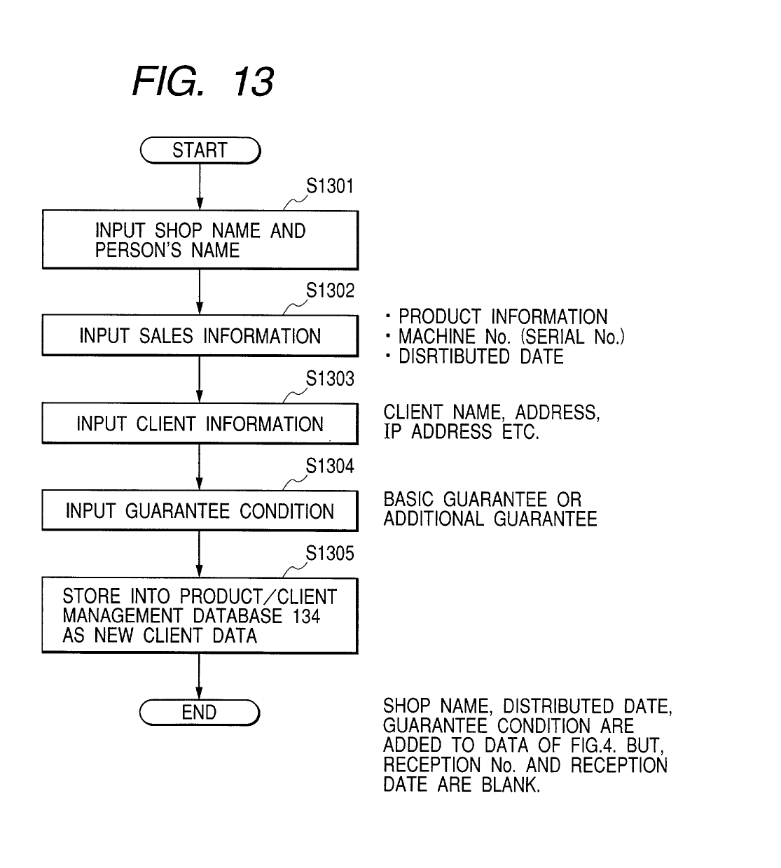

A fourth embodiment of the present invention will be described with reference to the flowchart of FIG. 13 with respect to a case where user information is stored in the database 134 when a client purchases a product at a shop.

The process of this information storage is executed by a salesperson in a shop at which the printer 111 is sold. That is, when the client purchases the printer 111 at the shop, the salesperson inputs necessary information by operating a salesperson's PC (not shown) installed at the shop.

Step S1301:

A shop name and a salesperson's name are input to the salesperson's PC.

Step S1302:

Sales information is input to the salesperson's PC.

Step S1303:

Client information obtained from the client is input to the salesperson's PC.

Step S1304:

Guarantee conditions are input to the salesperson's PC. If the client wishes to set a special condition such as an extension of the guarantee period in addition to basic guarantee, information about such a condition is input. With respect to basic guarantee conditions, default information may be automatically input without any special input operation.

Step S1305:

After the completion of input of predetermined user information, the salesperson's PC transmits the shop name to the client trouble management system 130 along with the various sorts of information input.

The user information is then stored as new client data in the client management database 134 of the client trouble management system 130. At this stage, only the client data is input since no trouble has occurred.

The user accesses the client trouble management system in step S201 of FIG. 2. User information is received in step S203. This information and the initial data stored in the database 134 in step S1305 are searched and collated with each other, and a reception number, a reception date and other information are stored to fill corresponding spaces which have been left blank.

The user may be instructed in step S202 to input changed information item in the data input at the time of purchase (a new address or telephone number due to a move or the like) and an item not yet input.

According to the fourth embodiment, the guarantee period can be accurately managed to enable accurate and prompt response to a request from the user in the event of trouble.

Needless to say, the object of the present invention can be achieved by supplying a system or an apparatus with a memory medium on which program codes of software for realizing the functions of the host and the terminal in each of the first to fourth embodiments are recorded, and by making a computer (or a CPU or a microprocessor unit (MPU)) provided in the system or apparatus retrieve and execute the program codes stored on the memory medium. In this case, the program codes themselves retrieved from the memory medium realize the functions of each of the first to fourth embodiments, and the memory medium on which the program codes are recorded constitutes the present invention.

The memory medium used to supply the program codes may be a read only memory (ROM), a floppy disk, a hard disk, an optical disk, a magneto-optical disc, a compact disk-read only memory (CD-ROM), a compact disc-recordable (CD-R), a magnetic tape, or a nonvolatile memory card.

Needless to say, the present invention comprises not only the step of realizing the functions of each of the first to fourth embodiments by executing the program codes retrieved by the computer but also a method in which an OS or the like running on the computer perform part or the whole of actual processing according to instructions provided by the program codes, and in which the functions of each of the first to fourth embodiments are realized by the processing.

Further, needless to say, the present invention also comprises a method in which the program codes retrieved from the memory medium are written to a memory provided in a function expansion board inserted in the computer or a function expansion unit connected to the computer, and in which a CPU or the like provided in the function expansion board or function expansion unit operates to perform part or the whole of actual processing according to instructions provided by the program codes, whereby the functions of each of the first to fourth embodiments are realized.

According to the present invention, as described above, information about kinds of troubles which may occur in a product during use of the product (information about a method for solving the trouble, information about contents of service operation for solving the trouble, etc.) is stored in advance, thereby making it always possible to immediately and correctly deal with a trouble in the event of its occurrence in the product.

According to the present invention, information about service on the product (contents of service operations, the cost of service, the time period required for service, and the progress of service by a service person) is also stored to enable the product user to immediately receive accurate information about the progress of the process of dealing with trouble, etc.

Also, since trouble diagnosis is performed automatically without any human operation, the present invention can be adapted to a process for dealing with product trouble on a 24-hour basis.

What is claimed is:

1. A trouble management system for managing a trouble in a product, comprising:
recording means for recording the progress of an operation for solving the trouble in the product; and
notice means for sending to a destination a notice of the progress of the operation recorded by said recording means,
wherein said notice means sends the notice by converting the progress of the operation recorded by said recording means into a format suitable for the destination.

2. A system according to claim 1, further comprising:
analysis means for analyzing information about the trouble in the product; and
search means for searching for the operation for resolving the trouble in the product on the basis of the result of said analysis.

3. A system according to claim 2, wherein analysis by said analysis means is performed on the side of a user using the product.

4. A system according to claim 2, wherein said notice means sends a notice of a cost or a time required for the operation.

5. A system according to claim 2, further comprising:
management means for managing a guarantee period of the product,
wherein said cost depends on the managed guarantee period.

6. A system according to claim 2, further comprising:
management means for managing information about specifications of the product,
wherein analysis by said analysis means depends on the managed information about the specifications.

7. A system according to claim 1, further comprising:
storage means for storing contents of the operation actually performed to resolve the trouble in the product or results of the operation.

8. A method of controlling a trouble management system for managing a trouble in a product, said method comprising:
a recording step of recording the progress of an operation for solving the trouble in the product; and
a notice step of sending to a destination a notice of the progress of the operation recorded in said recording step.

9. A storage medium storing a program for executing a process of controlling a trouble management system for managing a trouble in a product, the program storing:
a recording step of recording the progress of an operation for solving the trouble in the product; and
a notice step of sending to a destination a notice of the progress of the operation recorded in said recording step.

10. A trouble management method for managing a trouble in a product, comprising:
obtaining as an input contents of the trouble in the product;
recording the progress of an operation performed on the basis of the input contents of the trouble; and
sending a notice of the recorded progress of the operation.
